(19) United States
(12) Patent Application Publication
(10) Pub. No.: US 2009/0143523 A1
(43) Pub. Date: Jun. 4, 2009

(54) Cycloolefin additon polymer, composite material and molded article thereof, and optical material

(75) Inventors: Atsushi Ishiguro, Tokyo (JP); Shintaro Ikeda, Tokyo (JP); Yasuo Tsunogae, Tokyo (JP)

Correspondence Address: BIRCH STEWART KOLASCH & BIRCH, PO BOX 747, FALLS CHURCH, VA, 22040-0747, US

(73) Assignee: Zeon Corporation, Tokyo (JP)

(21) Appl. No.: 11/990,700

(22) PCT Filed: Aug. 11, 2006
(86) PCT No.: PCT/JP2006/315904

§ 371 Date: Jul. 30, 2008

(30) Foreign Application Priority Data
Aug. 30, 2005 (JP) 2005-249464

(51) Int. Cl. C08K 3/36; C08F 112/08; C08L 25/06; C08K 3/22

(52) U.S. Cl. 524/431; 526/347.1; 524/577; 524/433

(57) ABSTRACT

[Problems] To provide a cycloolefin addition polymer that is capable of satisfying high heat resistance and high refractive index simultaneously, a composite material of the cycloolefin addition polymer with an inorganic material, and a molded article thereof.

[Means for Solution] A cycloolefin addition polymer consisting essentially of a cycloolefin monomer unit and containing as an essential component a norbornene monomer unit having an aromatic ring. The cycloolefin addition polymer is preferably a cycloolefin addition polymer that consists essentially of a norbornene monomer unit having an aromatic ring. The cycloolefin addition polymers are excellent in heat resistance and have a high refractive index. The composite material is comprised of the cycloolefin addition polymer and an inorganic material. The molded article is obtained by molding the cycloolefin addition polymer or the composite material.

### TECHNICAL FIELD

The present invention relates to a cycloolefin addition polymer, a composite material and a molded article thereof, and an optical material. More specifically, the invention relates to a cycloolefin addition polymer consisting essentially of a cycloolefin monomer unit and containing as an essential component a norbornene monomer unit having an aromatic ring, a composite material comprised of the cycloolefin addition polymer and an inorganic material, a molded article obtained by molding the composite material, and an optical material comprised of the molded article.

### BACKGROUND ART

A cycloolefin addition polymer is used as a material for various optical products, such as an optical lens, e.g., an f·θ lens, a pickup lens and the like, an optical film, an optical disk, an optical fiber and the like, as a replacement for inorganic glass, owing to the excellent transparency, low water absorbing property and the like thereof, but other properties than the transparency and the low water absorbing property are demanded to be further improved, and in particular, such a cycloolefin addition polymer is demanded that satisfies heat resistance and refractive index simultaneously.

However, a cycloolefin addition polymer excellent in heat resistance has a relatively low refractive index, and thus may be restricted in usage as a material for an optical product (Patent Documents 1 and 2). A cycloolefin addition polymer having a relatively high refractive index has been known, on the other hand, but it often has a glass transition temperature of 200° C. or lower and is insufficient in heat resistance as a replacement for glass (Patent Documents 3, 4 and 5).

### Patent Document 1: JP-A-7-196736

### Patent Document 2: JP-T-11-505880 (WO 96/37526)

### Patent Document 3: JP-A-7-292179

Patent Document 4: JP-B-7-51609 (U.S. Pat. No. 4,931,520)

### Patent Document 5: JP-T-11-504669 (WO 96/35730)

### DISCLOSURE OF THE INVENTION

### Problems to be Solved by the Invention

Accordingly, an object of the invention is to develop a cycloolefin addition polymer that is capable of satisfying high heat resistance and high refractive index simultaneously. Another object of the invention is to develop a composite material of the cycloolefin addition polymer and an inorganic material. Still another object of the invention is to obtain a molded article by using the cycloolefin addition polymer or the composite material. A further object of the invention is to obtain an optical material comprised of the molded article.

### Means for Solving the Problems

As a result of earnest investigations made by the inventors for attaining the objects, it has been found that a cycloolefin polymer that has excellent transparency, low water absorbing property and a high refractive index, and is highly heat resistant as having a glass transition temperature of 200° C. or higher can be obtained by addition-polymerizing a particular cycloolefin monomer, and thus the invention has been completed based on the findings.

According to the invention, such a cycloolefin addition polymer is provided that consists essentially of a cycloolefin monomer unit and contains as an essential component a norbornene monomer unit having an aromatic ring (which may be hereinafter referred to as an “aromatic ring-containing cycloolefin addition polymer”).

It is preferred that, in the aromatic ring-containing cycloolefin addition polymer of the invention, the proportion of the norbornene monomer unit having an aromatic ring is 20% by mol or more based on the total cycloolefin monomer unit.

It is preferred that the aromatic ring-containing cycloolefin addition polymer of the invention has a polystyrene-equivalent number average molecular weight of from 5,000 to 800,000.

The cycloolefin addition polymer of the invention may consist essentially of a norbornene monomer unit having an aromatic ring (which may be hereinafter referred to as an “aromatic ring-containing norbornene addition polymer”).

It is preferred that the aromatic ring-containing norbornene addition polymer of the invention has a polystyrene-equivalent number average molecular weight of from 5,000 to 500,000.

It is preferred in the aromatic ring-containing cycloolefin addition polymer of the invention that the norbornene monomer unit having an aromatic ring has neither a halogen atom nor a functional group.

It is preferred that the aromatic ring-containing cycloolefin addition polymer of the invention has a glass transition temperature of 200° or higher.

It is preferred that the aromatic ring-containing cycloolefin addition polymer of the invention has a thermal decomposition starting temperature of 200° or higher.

It is preferred that the aromatic ring-containing cycloolefin addition polymer of the invention has a refractive index of from 1.54 to 1.80.

According to the invention, such a composite material is provided that is comprised of the aromatic ring-containing cycloolefin addition polymer and an inorganic material.

It is preferred in the composite material that the inorganic material is an oxide of at least one metal selected from the group consisting of silicon, aluminum, titanium and zirconium, or a siloxane compound.

In the composite material, the inorganic material may be glass fibers having been surface-treated with a silane coupling agent.

According to the invention, such a molded article is provided that is obtained by molding the aromatic ring-containing cycloolefin addition polymer or the composite material.

According to the invention, an optical material is further provided that is comprised of the molded article.

### ADVANTAGES OF THE INVENTION

The aromatic ring-containing cycloolefin addition polymer of the invention has excellent transparency and low water absorbing property, has a high refractive index, and has a glass transition temperature of 200° or higher. The molded article, obtained from the aromatic ring-containing cycloolefin addition polymer or the composite material comprised of the addition polymer and an inorganic material, is excellent in transparency, low hygroscopicity and heat resistance, and has a high refractive index. Accordingly, the molded article of the invention can be used favorably as various optical materials, such as an optical disk, an optical lens, an optical card, an optical fiber, an optical mirror, a substrate for a liquid crystal display device, a light guide plate, a polarizing film, a phase retardation film, an LED sealing agent, a substrate for a solar cell, a coating material and the like.

### BEST MODE FOR CARRYING OUT THE INVENTION

The aromatic ring-containing cycloolefin addition polymer of the invention consists essentially of a cycloolefin monomer unit.

The cycloolefin monomer is a hydrocarbon that has a cyclic structure and has one or two or more double bonds in the cyclic structure. The cyclic structure may be a monocyclic ring or a condensed ring. A carbon atom constituting the cyclic structure may have a substituent thereon.

Specific examples of the monocyclic cycloolefin monomer include cyclobutene, cyclopentene, cyclohexene, cyclooctene and the like. The cycloolefin monomer having a condensed ring structure is not particularly limited, and preferred examples thereof include a norbornene ring structure-containing cycloolefin monomer represented by the general formula (I), such as norbornene, dicyclopentadiene and the like:

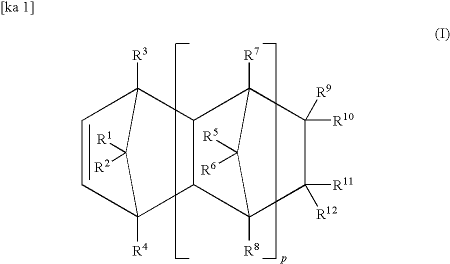

In the general formula (I), R¹ to R¹² each independently represents a hydrogen atom; a halogen atom, such as a fluorine atom, a chlorine atom, and a bromine atom; a functional group containing a halogen atom, an oxygen atom, a nitrogen atom, a sulfur atom or a silicon atom; or a hydrocarbon group having from 1 to 20 carbon atoms that may have a halogen atom or the functional group. Furthermore, R⁹ to R¹² may be bonded together to form a monocyclic ring or a condensed ring. p represents an integer of 0 or 1 or more.

Specific examples of the functional group containing an oxygen atom include a hydroxy group, an alkoxy group, a carbonyl group, a hydroxycarbonyl group, an alkoxycarbonyl group, an acid anhydride group and the like. Specific examples of the functional group containing a nitrogen atom include an amino group, an alkylamino group, a cyano group, an aminocarbonyl group, an alkylaminocarbonyl group and the like. Specific examples of the functional group containing a sulfur atom include a mercapto group, an alkylthio group and the like. Specific examples of the functional group containing a silicon atom include a silyl group, an alkylsilyl group, an alkoxysilyl group and the like.

In the case of p=0 in the general formula (I), the norbornene ring structure-containing cycloolefin monomer is bicyclo[2.2.1]hept-2-ene (i.e., 2-norbornene) or a derivative thereof.

Specific examples of the 2-norbornene derivative include a compound having only a norbornene ring as a cyclic structure in the other part than the substituent, such as 5-methyl-2-norbornene, 5-ethyl-2-norbornene, 5-butyl-2-norbornene, 5-hexyl-2-norbornene, 5-decyl-2-norbornene, 5-cyclohexyl-2-norbornene, 5-cyclopentyl-2-norbornene, 5-ethylidene-2-norbornene, 5-vinyl-2-norbornene, 5-propenyl-2-norbornene, 5-cyclohexenyl-2-norbornene, 5-cyclopentenyl-2-norbornene, 5,6-dimethyl-2-norbornene, 1-methyl-2-norbornene, and 7-methyl-2-norbornene;

a compound having a structure comprised of a 5-membered ring condensed with a norbornene ring as a cyclic structure, such as tricyclo[4.3.0.1^{2,5}]deca-3,7-diene (dicyclopentadiene), tricyclo[4.3.0.1^{2,5}]dec-3-ene (dihydrodicyclopentadiene), 2-methyldicyclopentadiene, and 2-methyldihydrodicyclopentadiene;

a compound having a tricycloundecene ring structure comprised of a 5-membered ring condensed a 6-membered ring with a norbornene ring as a cyclic structure, such as tricyclo[4.4.0.1^{2,5}]undec-3-ene and 10-methyltricyclo[4.4.0.1^{2,5}]undec-3-ene; and the like.

In the case of p=1 in the general formula (I), the norbornene ring structure-containing cycloolefin monomer is tetracyclo[4.4.0.1^{2,5}.1^{7,10}]dodec-3-ene (i.e., tetracyclododecene) or a derivative thereof.

Specific examples of the tetracyclo[4.4.0.1^{2,5}.1^{7,10}]dodec-3-ene derivative include a compound having a tetracyclododecene ring, such as 8-methyltetracyclo[4.4.0.1^{2,5}.1^{7,10}]dodec-3-ene, 8-ethyltetracyclo[4.4.0.1^{2,5}.1^{7,10}]dodec-3-ene, 8-butyltetracyclo[4.4.0.1^{2,5}.1^{7,10}]dodec-3-ene, 8-cyclohexyltetracyclo[4.4.0.1^{2,5}.1^{7,10}]dodec-3-ene, 8-methylidenetetracyclo[4.4.0.1^{2,5}.1^{7,10}]dodec-3-ene, 8-ethylidenetetracyclo[4.4.0.1^{2,5}.1^{7,10}]dodec-3-ene, 8-vinyltetracyclo[4.4.0.1^{2,5}.1^{7,10}]dodec-3-ene, 8-propenyltetracyclo[4.4.0.1^{2,5}.1^{7,10}]dodec-3-ene, 8-cyclohexenyltetracyclo[4.4.0.1^{2,5}.1^{7,10}]dodec-3-ene, 8-cyclopentenyltetracyclo[4.4.0.1^{2,5}.1^{7,10}]dodec-3-ene, and 8,9-dimethyltetracyclo[4.4.0.1^{2,5}.1^{7,10}]dodec-3-ene;

a compound having a pentacyclopentadecene ring, such as pentacyclo[6.5.1.1^{3,6}.0^{2,7}.0^{9,13}]pentadec-4-ene and 1,3-dimethylpentacyclo[6.5.1.1^{3,6}.0^{2,7}.0^{9,13}]pentadec-4-ene;

a compound having a pantacyclohexadecene ring, such as pentacyclo[6.5.1.1^{3,6}.0^{2,7}.0^{9,14}]hexadec-4-ene and 1,3-dimethylpentacyclo[6.5.1.1^{3,6}.0^{2,7}.0^{9,14}]hexadec-4-ene; and the like.

Specific examples of the norbornene ring structure-containing cycloolefin monomer of the general formula (I), wherein p=2 or more, include a compound having a hexacycloheptadecene ring, such as hexacyclo[6.5.1.1^{3,6}.0^{2,7}.0^{9,14}]heptadec-4-ene; a compound having a heptacycloeicosene ring, such as heptacyclo[8.7.0.1^{2,9}.1^{4,7}.1^{11,17}.0^{3,8}.0^{12,16}]eicos-5-ene; a compound having an octacyclodocosene ring, such as octacyclo[8.8.0.1^{2,9}.1^{4,7}.1^{11,18}.1^{13,16}.0^{3,8}.0^{12,17}]docos-5-ene; and the like.

Specific examples of the norbornene ring structure-containing cycloolefin monomer of the general formula (I), wherein R⁹ to R¹² are functional groups, include the following compound:

a bicyclo[2.2.1]hept-2-ene compound having an alkoxycarbonyl group, such as methyl 5-norbornene-2-carboxylate, ethyl 5-norbornene-2-carboxylate, methyl 2-methyl-5-norbornene-2-carboxylate, and ethyl 2-methyl-5-norbornene-2-carboxylate; a tetracyclo[4.4.0.1^{2,5}.1^{7,10}]dodec-4-ene compound having an alkoxycarbonyl group, such as methyl tetracyclo[4.4.0.1^{2,5}.1^{7,10}]dodec-9-ene-4-carboxylate, and methyl 4-methyltetracyclo[4.4.0.1^{2,5}.1^{7,10}]dodec-9-ene-4-carboxylate;

a bicyclo[2.2.1]hept-2-ene compound having a hydroxycarbonyl group or an acid anhydride group, such as 5-norbornene-2-carboxylic acid, 5-norbornene-2,3-dicarboxylic acid, and 5-norbornene-2,3-dicarboxylic anhydride; a tetracyclo[4.4.0.1^{2,5}.1^{7,10}]ododec-4-ene compound having a hydroxycarbonyl group or an acid anhydride group, such as tetracyclo[4.4.0.1^{2,5}.1^{7,10}]dodec-9-ene-4-carboxylic acid, tetracyclo[4.4.0.1^{2,5}.1^{7,10}]dodec-9-ene-4,5-dicarboxylic acid, and tetracyclo[4.4.0.1^{2,5}.1^{7,10}]dodec-9-ene-4,5-dicarboxylic anhydride;

a bicyclo[2.2.1]hept-2-ene compound having a hydroxy group, such as 5-hydroxy-2-norbornene, 5-hydroxymethyl-2-norbornene, 5,6-di(hydroxymethyl)-2-norbornene, 5,5-di(hydroxymethyl)-2-norbornene, 5-(2-hydroxyethoxycarbonyl)-2-norbornene, and 5-methyl-5-(2-hydroxyethoxycarbonyl)-2-norbornene; a tetracyclo[4.4.01^{2,5}.1^{7,10}]dodec-4-ene compound having a hydroxy group, such as tetracyclo[4.4.0.1^{2,5}.1^{7,10}]dodec-9-ene-4-methanol and tetracyclo[4.4.0.1^{2,5}.1^{7,10}]dodec-9-ene-4-ol;

a bicyclo[2.2.1]hept-2-ene compound having a hydrocarbonyl group, such as 5-norbornene-2-carbaldehyde; a tetracyclo[4.4.0.1^{2,5}.1^{7,10}]dodec-4-ene compound having a hydrocarbonyl group, such as tetracyclo[4.4.0.1^{2,5}.1^{7,10}]dodec-9-ene-4-carbaldehyde;

a bicyclo[2.2.1]hept-2-ene compound having an alkoxycarbonyl group and a hydroxycarbonyl group, such as 3-methoxycarbonyl-5-norbornene-2-carboxylic acid;

a bicyclo[2.2.1]hept-2-ene compound having a carbonyloxy group, such as 5-norbornene-2-yl acetate, 2-methyl-5-norbornen-2-yl acetate, 5-norbornen-2-yl acrylate, and 5-norbornen-2-yl methacrylate; a tetracyclo[4.4.0.1^{2,5}.1^{7,10}]dodec-4-ene compound having a carbonyloxy group, such as 9-tetracyclo[4.4.0.1^{2,5}.1^{7,10}]dodec-4-enyl acetate, 9-tetracyclo[4.4.0.1^{2,5}.1^{7,10}]dodec-4-enyl acetate, 9-tetracyclo[4.4.0.1^{2,5}.1^{7,10}]dodec-4-enyl acrylate, and 9-tetracyclo[4.4.0.1^{2,5}.1^{7,10}]dodec-4-enyl methacrylate;

a bicyclo[2.2.1]hept-2-ene compound having a functional group containing a nitrogen atom, such as 5-norbornene-2-carbonitrile, 5-norbornene-2-carboxamide, and 5-norbornene-2,3-dicarboxylic imide; a tetracyclo[4.4.0.1^{2,5}.1^{7,10}]dodec-4-ene compound having a functional group containing a nitrogen atom, such as tetracyclo[4.4.0.1^{2,5}.1^{7,10}]dodec-9-ene-4-carbonitrile, tetracyclo[4.4.0.1^{2,5}.1^{7,10}]dodec-9-ene-4-carboxamide, and tetracyclo[4.4.0.1^{2,5}.1^{7,10}]dodec-9-ene-4,5-dicarboxylic imide;

a bicyclo[2.2.1]hept-2-ene compound having a halogen atom, such as 5-chloro-2-norbornene; a tetracyclo[4.4.0.1^{2,5}.1^{7,10}]dodec-4-ene compound having a halogen atom, such as 9-chlorotetracyclo[4.4.0.1^{2,5}.1^{7,10}]dodec-4-ene;

a bicyclo[2.2.1]hept-2-ene compound having a functional group containing a silicon atom, such as 5-trimethoxysilyl-2-norbornene and 5-triethoxysilyl-2-norbornene; and a tetracyclo[4.4.0.1^{2,5}.1^{7,10}]dodec-4-ene compound having a functional group containing a silicon atom, such as 4-trimethoxysilyltetracyclo[4.4.0.1^{2,5}.1^{7,10}]dodec-9-ene and 4-triethoxysilyltetracyclo[4.4.0.1^{2,5}.1^{7,10}]dodec-9-ene.

Among these, the norbornene ring structure-containing cycloolefin monomers of the general formula (I), wherein R¹ to R¹² are each a hydrogen atom or a hydrocarbon group having neither a halogen atom nor a functional group, are preferred.

In the invention, the norbornene ring structure-containing cycloolefin monomer may be used solely as a single kind or used in combination of two or more kinds thereof.

The aromatic ring-containing cycloolefin addition polymer of the invention comprises a norbornene monomer unit having an aromatic ring as an essential component.

In the aromatic ring-containing cycloolefin addition polymer of the invention, the ratio of the norbornene monomer unit having an aromatic ring is preferably 20% by mol or more, and more preferably 30% by mol or more, from the standpoint of refractive index.

The ratios of the repeating monomer units present in the aromatic ring-containing cycloolefin addition polymer of the invention can be measured by ¹H-NMR and ¹³C-NMR spectroscopic analysis.

The mode of distribution of the bonds of the norbornene monomer units having an aromatic ring in the aromatic ring-containing cycloolefin addition polymer of the invention is not particularly limited and may be random or block.

The aromatic ring-containing cycloolefin addition polymer of the invention may be a polymer consisting essentially of a norbornene monomer unit having an aromatic ring (aromatic ring-containing norbornene addition polymer). From the standpoint of heat resistance and refractive index of the aromatic ring-containing cycloolefin addition polymer, the polymer consisting essentially of a norbornene monomer unit having an aromatic ring (aromatic ring-containing norbornene addition polymer) is preferred.

The norbornene monomer having an aromatic ring is preferably a compound represented by the general formula (I), wherein at least one of R⁹ to R¹² represents the following general formula (II):

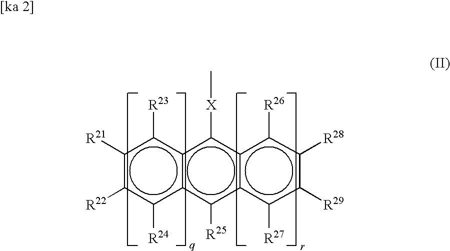

In the general formula (II), q and r each represents 0 or a positive integer, and preferably 0, 1 or 2.

X represents a group selected from the group consisting of —(CH₂)_{d}—, —O—, —C(═O)—, —C(═O)O—, —OC(═O)—, —OC(═O)O— and —C(═O)—N(R³⁰)—; d represents 0 or a positive integer; and R³⁰ represents hydrogen, an aryl group or an alkyl group, or represents —C(═O)— bonded to a carbon to which R⁹ to R¹² are bonded.

Among these, X preferably represents —(CH₂)_{d}—, and more preferably a single bond (i.e., d=0).

R²¹ to R²⁹ may be the same as or different from each other, and each represent a hydrogen atom, a halogen atom, an aliphatic hydrocarbon group, an aromatic hydrocarbon group or an alkoxy group.

Examples of the halogen atom include a fluorine atom, a chlorine atom, a bromine atom and an iodine atom.

Examples of the aliphatic hydrocarbon group include an optionally substituted alkyl group having from 1 to 20 carbon atoms, and an optionally substituted cycloalkyl group having from 3 to 15 carbon atoms. More specifically, examples of the alkyl group include a methyl group, an ethyl group, a propyl group, an isopropyl group, an amyl group, a hexyl group, an octyl group, a decyl group, a dodecyl group, an octadecyl group and the like. Examples of the cycloalkyl group include a cyclohexyl group and the like.

Examples of the aromatic hydrocarbon group include an aryl group, which may have a substituent. Specific examples thereof include a phenyl group, a tolyl group, a naphthyl group, a benzyl group and the like.

R²¹ or R²³ may be bonded to R¹¹ or R¹² in the general formula (I) directly or through an alkylene group having from 1 to 3 carbon atoms. R²⁶ or R²⁸ may be bonded to R⁹ or R¹⁰ in the general formula (I) directly or through an alkylene group having from 1 to 3 carbon atoms. In these cases, accordingly, the general formula (I) and the general formula (II) form a condensed ring.

R²¹ to R²⁹ may be bonded to each other in an arbitrary combination to form a saturated or unsaturated monocyclic or polycyclic ring.

For example, in the case where p=q=r=0, R⁹ is bonded to X, and X is a single bond (d=0), when R¹¹ and R²¹ are bonded through a methylene bond, the norbornene monomer having an aromatic ring is a 1,4-methano-1,4,4a,9a-tetrahydro-9H-fluorene compound represented by the general formula (III):

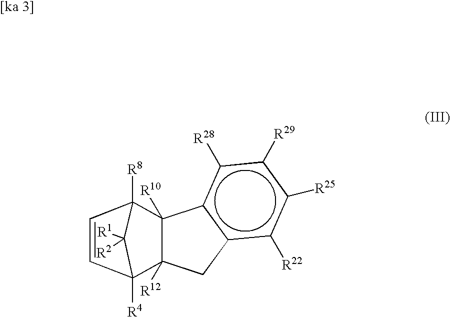

In the general formula (III), R¹ to R⁴, R¹⁰, R¹², R²², R²⁵, R²⁸ and R²⁹ are the same as in the general formulae (I) and (II).

In the general formula (III), R¹ to R⁴, R¹⁰, R¹², R²², R²⁵, R²⁸ and R²⁹ each preferably represents a hydrogen atom or a hydrocarbon group having neither a halogen atom nor a functional group.

Preferred specific examples of the aromatic ring-containing norbornene monomer represented by the general formulae (I) and (II) include 5-phenyl-biyclo[2.2.1]hept-2-ene, 5-o-tolyl-bicyclo[2.2.1]hept-2-ene, 5-m-tolyl-bicyclo[2.2.1]hept-2-ene, 5-p-tolyl-bicyclo[2.2.1]hept-2-ene, 5-o-ethylphenyl-bicyclo[2.2.1]hept-2-ene, 5-m-ethylphenyl-bicyclo[2.2.1]hept-2-ene, 5-p-ethylphenyl-bicyclo[2.2.1]hept-2-ene, 5-p-isopropylphenyl-bicyclo[2.2.1]hept-2-ene, 1,2-(2H,3H-[1,3]epicyclopenta)-1,2-dihydroacenaphthylene, 8-phenyltetracyclo[4.4.0.1^{2,5}.1^{7,10}]dodec-3-ene, 5-(naphthalen-1-yl)bicyclo[2.2.1]hept-2-ene, 1,4-methano-1,4,4a,9a-tetrahydro-9H-fluorene and the like.

Among these, 5-phenyl-biyclo[2.2.1]hept-2-ene and a derivative thereof, and 1,4-methano-1,4,4a,9a-tetrahydro-9H-fluorene and a derivative thereof are preferred, and 5-phenyl-biyclo[2.2.1]hept-2-ene and 1,4-methano-1,4,4a,9a-tetrahydro-9H-fluorene are particularly preferred.

In the invention, the norbornene monomer having an aromatic ring may be used solely as a single kind or used in combination of two or more kinds thereof.

The aromatic ring-containing norbornene monomer can be produced, for example, by subjecting cyclopentadiene and an olefin having a structure corresponding to the aromatic ring-containing norbornene monomer to a Diels-Alder reaction.

The molecular weight of the aromatic ring-containing cycloolefin addition polymer of the invention is, in terms of polystyrene-equivalent number average molecular weight, from 5,000 to 800,000, preferably from 10,000 to 600,000, and more preferably from 20,000 to 500,000. In the case where the molecular weight is within the range, a melt viscosity is within a suitable range to provide excellent moldability, whereby a molded article excellent in strength can be obtained.

In the case where the aromatic ring-containing cycloolefin addition polymer of the invention is the aromatic ring-containing norbornene addition polymer, the number average molecular weight thereof is not particularly limited and is generally, in terms of polystyrene-equivalent number average molecular weight, from 5,000 to 500,000, preferably from 25,000 to 400,000, and more preferably from 50,000 to 300,000.

The number average molecular weight of the aromatic ring-containing cycloolefin addition polymer can be controlled by the polymerization temperature, the amount of the polymerization catalyst, the monomer concentration, addition of a molecular weight modifier, and the like, and it is preferable by that the polymerization is carried out in the presence of a molecular weight modifier.

As the molecular weight modifier, an α-olefin, such as ethylene, propylene, 1-butene, 1-pentene, 1-hexene, 3-methyl-1-butene, 3-methyl-1-pentene, 3-ethyl-1-pentene, 4-methyl-1-pentene, 4-methyl-1-hexene, 4,4-dimethyl-1-hexene, 4,4-dimethyl-1-pentene, 4-ethyl-1-hexene, 3-ethyl-1-hexene, 1-octene, 1-decene, 1-dodecene, 1-tetradecene, 1-hexadecene, 1-octadecene, and 1-eicosene; a styrene compound, such as styrene, α-methylstyrene, o-methylstyrene, m-methylstyrene, p-methylstyrene, 2,3-dimethylstyrene, 2,4-dimethylstyrene, 2,5-dimethylstyrene, p-t-butylstyrene, and 2,4,6-trimethylstyrene; a silane compound, such as vinyltrimethoxysilane, vinyltriethoxysilane, vinyltri-i-propoxysilane, vinyltri-n-butylsilane, allyltrimethoxysilane, allyltriethoxysilane, allyltri-i-propoxysilane, vinyldimethyldimethoxysilane, vinyldimethyldiethoxysilane, allyldimethyldimethoxysilane, and allyldimethyldiethoxysilane; an acrylate ester, such as methyl acrylate; hydrogen; and the like can be used. Among these, an α-olefin, a styrene compound and a silane compound are preferred, and a styrene compound and a silane compound are more preferred.

In the case where the molecular weight is controlled by using an α-olefin, an olefinic unsaturated bond may be formed at the end of the aromatic ring-containing cycloolefin addition polymer in some cases.

The olefinic unsaturated bond at the end of the polymer and an olefinic unsaturated bond contained in the polymer in the case where a cycloolefin compound containing an olefinic unsaturated bond in the side chain substituent is used as a monomer may be hydrogenated for improving the thermal stability.

The method of hydrogenation is not particularly limited and may be a method capable of hydrogenating a carbon-carbon unsaturated bond efficiently. In general, hydrogenation is carried out in the presence of a hydrogenation catalyst in an inert solvent under a hydrogen pressure of 0 (under stream) to 15 MPa and a reaction temperature of from 0 to 250° C.

As the inert solvent, an aliphatic hydrocarbon having from 5 to 14 carbon atoms, such as pentane, hexane, heptane, octane, and dodecane; an alicyclic hydrocarbon having from 5 to 14 carbon atoms, such as cyclopentane, cyclohexane, cycloheptane, cyclodecane, and methylcyclohexane; an aromatic hydrocarbon having from 6 to 14 carbon atoms, such as benzene, toluene, xylene, and ethylbenzene; and the like are preferably used. Among these, cyclohexane, methylcyclohexane, toluene and xylene are most preferably used.

Examples of the hydrogenation catalyst include a solid catalyst comprised of a Group 8 to 10 metal, such as nickel, palladium, platinum, cobalt, ruthenium, and rhodium, or a compound thereof supported on a porous carrier, such as carbon, alumina, silica, silica-alumina, and diatomaceous earth, and a uniform catalyst, such as a combination of an organic carboxylate salt of a Group 8 to 10 metal, such as cobalt, nickel, and palladium or a β-diketone compound with organoaluminum or organolithium, a complex of ruthenium, rhodium, iridium or the like, and the like.

Removal of the catalyst from the cycloolefin addition polymer of the invention having been addition-polymerized or further hydrogenated can be carried out in such a method as a method of causing the polymerization solution to adsorb to an adsorbent, such as diatomous earth, silica, alumina, and activated carbon, a method for removing with an ion exchange resin, a method of adding a polyfunctional amine compound, an aminoalcohol compound, a phosphine compound or the like that forms a chelate with a palladium compound or an aluminum compound to the polymerization solution, followed by filtering the chelate thus formed, or a method of putting the copolymerization solution into an alcohol, such as ethanol and propanol, or a ketone, such as acetone and methyl ethyl ketone, to coagulate the polymer and removing the polymer.

The aromatic ring-containing cycloolefin addition polymer of the invention is excellent in transparency and generally has a total light transmittance of 85% or more, and preferably 90% or more.

The aromatic ring-containing cycloolefin addition polymer of the invention is excellent in heat resistance, and the thermal decomposition starting temperature thereof is generally 200° or higher, preferably 250° or higher, and further preferably 300° or higher. Similarly, the glass transition temperature thereof is generally 200° or higher, preferably 250° or higher, and further preferably 300° or higher.

In the case where the aromatic ring-containing cycloolefin addition polymer of the invention is the aromatic ring-containing norbornene addition polymer, the thermal decomposition starting temperature thereof is generally 250° or higher, and preferably 300° or higher. Similarly, the glass transition temperature thereof is generally 250° or higher, and preferably 300° or higher.

The aromatic ring-containing cycloolefin addition polymer of the invention preferably has a refractive index of from 1.54 to 1.80. In the case where the aromatic ring-containing cycloolefin addition polymer of the invention is the aromatic ring-containing norbornene addition polymer, in particular, the refractive index thereof is preferably as high as from 1.57 to 1.80.

The aromatic ring-containing cycloolefin addition polymer of the invention can be produced by polymerizing a cycloolefin monomer that contains as an essential component a norbornene monomer having an aromatic ring in the presence of a polymerization catalyst containing a combination of a transition metal complex (a) with an organoaluminum compound (b) and/or a boron compound (c).

The transition metal complex (a) is not particularly limited as far as it is a complex of a transition metal, and preferred examples thereof include a transition metal complex having a structure containing a bidentate ligand having two nitrogen atoms as coordinating atoms coordinated to a Group 8 to 10 transition metal in the periodic table, in which the two nitrogen coordinating atoms of the bidentate ligand, one carbon atom sandwiched between the two nitrogen coordinating atoms, and the transition metal form a 4-membered ring.

The transition metal is preferably a Group 8 to 10 transition metal in the periodic table, and examples thereof include cobalt, nickel, palladium, platinum, rhodium and the like. Among these, nickel and palladium are particularly preferred.

Specific examples of the palladium complex include (allyl) palladium (tricyclohexylphosphine) chloride, (allyl) palladium (tricyclohexylphosphine) bromide, (allyl) palladium (tricyclohexylphosphine) iodide, (allyl) palladium (triphenylphosphine) chloride, (allyl) palladium (triphenylphosphine) bromide, (allyl) palladium (triphenylphosphine) iodide and the like.

Specific examples of the nickel complex include a compound represented by the following general formula (IV):

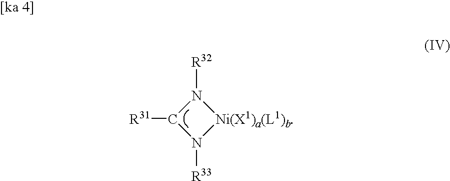

In the formula (IV), R³¹ to R³³ each independently represents a hydrogen atom; a halogen atom; a functional group containing a halogen atom, an oxygen atom, a nitrogen atom, a sulfur atom or a silicon atom; or a hydrocarbon group having from 1 to 20 carbon atoms, which may have a halogen atom or the functional group. L¹ represents a neutral electron donating ligand, and X¹ represents an anionic ligand. L¹ and X¹ may be bonded to each other to form a polydentate ligand. a and b each represents an integer of from 0 to 3, and a plurality of L¹ and X¹ may be the same as or different from each other.

Specific examples of the nickel compound represented by the formula (IV) include N,N′-bis-(2,6-diisopropylphenyl)benzamidinate nickel (triphenylphosphine) chloride, N,N′-bis-(phenyl)benzamidinate nickel (triphenylphosphine) chloride, N,N′-bis-(2,4,6-trimethylphenyl)benzamidinate nickel (triphenylphosphine) chloride, N,N′-bis-(2-methylphenyl)benzamidinate nickel (triphenylphosphine) chloride, N,N′-bis-(4-methylphenyl)benzamidinate nickel (triphenylphosphine) chloride, N,N′-bis-(4-t-butylphenyl)benzamidinate nickel (triphenylphosphine) chloride, N,N′-bis-(2,3,4,5,6-pentafluorophenyl)benzamidinate nickel (triphenylphosphine) chloride and the like.

The organoaluminum compound (b) and the boron compound (c) used together with the transition metal complex are activating agents that activate the transition metal complex.

The organoaluminum compound (b) is not particularly limited as far as it is an aluminum compound having an organic group. Specific examples thereof include a trialkylaluminum, such as trimethylaluminum, triethylaluminum, trioctylaluminum, triisopropylaluminum, triisobutylaluminum, and tri-sec-butylaluminum; a triarylaluminum, such as triphenylaluminum and tritolylaluminum; a dialkylaluminum hydride, such as diisobutylaluminum hydride; a dialkylaluminum alkoxide, such as dimethylaluminum methoxide, diethylaluminum ethoxide, and dibutylaluminum butoxide; and the like.

The organoaluminum compound may be a known aluminoxane, and may be a benzene-insoluble organoaluminumoxy compound disclosed, for example, in JP-A-2-78687.

The boron compound (c) reacts with the transition metal complex to convert it to a cationic species. Specific examples of the boron compound include a borate compound, such as triethylammonium tetrakis(pentafluorophenyl)borate, trityl tetrakis(pentafluorophenyl)borate, N,N′-dimethylanilinium tetrakis(pentafluorophenyl)borate, ferrocenium tetra(pentafluorophenyl)borate, and lithium tetrakis(pentafluorophenyl)borate; a boron compound, such as tris(4-fluorophenyl)boron, tris(3,5-difluorophenyl)boron, tris(4-fluoromethylphenyl)boron, and tris(pentafluorophenyl)boron; and the like.

As the mode of polymerization of the cycloolefin monomer, any one of solution polymerization, bulk polymerization and slurry polymerization may be employed, and the polymerization may be carried out by either one of a continuous system and a batch system.

Examples of the polymerization solvent include an aliphatic hydrocarbon, such as hexane, heptane, octane, and kerosene; an alicyclic hydrocarbon, such as cyclohexane and methylcyclohexane; an aromatic hydrocarbon, such as benzene, toluene, and xylene; and the like. The solvent may be used solely as a single kind or used in combination of two or more kinds thereof.

The polymerization temperature is within a range of from −50 to +230° C., preferably from −30 to +200° C., and further preferably from −20 to +150° C., and the polymerization reaction time is from 1 minute to 24 hours, and preferably from 5 minutes to 16 hours.

The method for adding the polymerization catalyst is not particularly limited, and the transition metal complex (a), the organoaluminum compound (b) and the boron compound (c) may be added separately to the reactor, or may be made in contact with each other outside the system of a polymerization vessel in advance.

The ratio of the transition metal complex used with respect to the monomer (transition metal atom in transition metal complex/monomer) is, in terms of molar ratio, generally from 1/100 to 1/2,000,000, preferably from 1/200 to 1/1,000,000, and more preferably from 1/500 to 1/500,000. The amount of the organoaluminum compound or the boron compound used is preferably from 1 to 10,000 equivalents based on the transition metal complex.

Upon polymerization of the aromatic ring-containing cycloolefin addition polymer of the invention, desired monomer unit composition ratios can be obtained by appropriately changing the charge ratios of the monomers.

The method for adding the monomers is not particularly limited, and the entire monomers may be added at the same time to a polymerization vessel for starting polymerization, or polymerization may be started by using a part of the monomers, followed by successive addition of the balance. The successive addition may be continuous or intermittent.

The method for adding the catalyst is not particularly limited and may be added before, after or simultaneously with the addition of the monomers, wholly at the same time or dividedly.

After completion of the polymerization, the target polymer or copolymer can be isolated by removal of the catalyst and drying in ordinary methods.

The aromatic ring-containing cycloolefin addition polymer of the invention may be formed into a composite material with an inorganic material.

The inorganic material used in the invention is not particularly limited and is preferably an oxide of at least one metal selected from the group consisting of silicon, aluminum, titanium and zirconium, a siloxane compound, or glass fibers surface-treated with a silane coupling agent.

The oxide of at least one metal selected from the group consisting of silicon, aluminum, titanium and zirconium is not particularly limited, and specific examples thereof include silica, diatomous earth, alumina, titanium oxide, zirconium oxide, pumicite powder, pumice balloons, aluminum hydroxide, talc, clay, mica, glass flakes, glass beads, calcium silicate, montmorillonite, bentonite, aluminum powder and the like, with silica, alumina, titanium oxide and zirconium oxide being preferred.

The shape of the metallic oxide is not particularly limited and is preferably a spherical shape, an acicular shape, a scale shape or the like. The particle diameter of the metallic oxide is not particularly limited and is preferably from 0.001 to 800 μm, more preferably from 0.001 to 500 μm, and particularly preferably from 0.001 to 200 μm.

The amount of the metallic oxide used may be appropriately selected depending on requirements and is preferably about from 20 to 80% by weight based on the polymer.

The siloxane compound is not particularly limited and may be a monosiloxane or a polysiloxane, and may be an alkylsiloxane, an alkoxysiloxane or an alkoxyalkylsiloxane. Specific examples thereof include methoxytrimethylsiloxane, butoxytrimethylsiloxane, pentamethyldisiloxane, hexamethyldisiloxane, hexamethylcyclotrisiloxane, decamethylcyclopentasiloxane, dodecamethylcyclohexasiloxane and the like.

The amount of the siloxane compound used is generally from 3 to 50 parts by weight, and preferably from 5 to 30 parts by weight, per 100 parts by weight of the aromatic ring-containing cycloolefin addition polymer.

The inorganic material used in the composite material may be glass fibers surface-treated with a silane coupling agent.

The glass fibers are preferably continuous glass fibers. The form of the glass fibers is not particularly limited and may be any one of a woven fabric, a knitted fabric, a continuous strand mat, a filament winding and the like. The glass fibers are not limited to a single species or a single form and may be used in combination of two or more species or two or more forms.

The surface-treating agent for the glass fibers is not particularly limited, and a silane coupling agent is preferred. Examples of the silane coupling agent include amino-alkoxysilane, vinyl-alkoxysilane, acrylic-alkoxysilane, alkyl-alkoxysilane, allyl-alkoxysilane, aryl-alkoxysilane, epoxy-alkoxysilane, alkoxy-silsesquioxane and the like. Among these, an alkoxysilane having an amino group, an acrylic group or an epoxy group is preferred.

The form of the composite material is not particularly limited and may be any one of a solid form, a solution form, an emulsion form, a suspension form, a slurry form and the like.

The aromatic ring-containing cycloolefin addition polymer of the invention and the composite material thereof with an inorganic material may be formed into a molded article.

The molding method is not particularly limited as far as molding can be carried out, examples thereof include a solution casting method (casting method), an extrusion molding method, a calendar molding method, an inflation molding method, a compression molding method, a transfer molding method, an injection molding method, a heat press molding method and the like.

The shape of the molded article is not particularly limited, and the molded article may be used in various shapes, such as a film shape, a sheet shape, a thin film shape, a rod shape, a plate shape, a cylindrical shape, a hemispherical shape, a prismatic shape, a tubular shape, and a fibrous shape.

Upon molding, various additives may be compounded. Examples of the additive include an antioxidant; an ultraviolet absorber; a weather stabilizer; an antistatic agent; a light stabilizer; a near infrared ray absorber; a colorant, such as a dye and a pigment; a lubricant; a plasticizer; an antiblocking agent; a fluorescent whitening agent; a deodorizer; a filler; a crosslinking agent; a vulcanizing agent; other synthetic resin and rubber polymer; and the like.

The aromatic ring-containing cycloolefin addition polymer of the invention has high transparency and high refractive index and is excellent in low hygroscopicity and heat resistance, and the molded article of the invention obtained therefrom is suitable as an optical material.

Specific examples of the optical material include a substrate of an optical recording medium and a optomagnetic recording medium; a lens or prism, such as a spectacle lens, an f·θ lens and a pickup lens; an optical card; an optical fiber; an optical mirror; a member for a liquid crystal display, such as a substrate for a liquid crystal display device, a light guide plate, a polarizing film, a phase retardation film, and a viewing angle compensation film; an optical device sealing agent; a substrate for a solar cell; an LED sealing agent; and the like.

### EXAMPLES

The invention will be described more specifically with reference to examples and comparative examples below. The invention is not limited to the examples. All parts and percents in the examples are in weight basis unless otherwise indicated.

The characteristics of the polymers, the composite materials and the molded articles are evaluated in the following manners.

### (1) Weight Average Molecular Weight (Mw) and Number Average Molecular Weight (Mn) of Polymer

They are measured as polystyrene-equivalent values by gel permeation chromatography (GPC) with chloroform as a solvent.

### (2) Amount of Recurring Units Present in Copolymer

They are obtained by ¹H-NMR and ¹³C-NMR spectroscopic analysis in chloroform-d as a solvent.

### (3) Glass Transition Temperature (Tg) of Polymer

The inflexion point temperature of the temperature variance of the storage elastic modulus in the dynamic viscoelasticity, which is measured under conditions of a measuring frequency of 10 Hz, a temperature-increasing rate of 5° C. per minute, a vibration mode of a single waveform, and a vibration amplitude of 2.5 μm, is measured.

### (4) Refractive Index

It is measured according to ASTM D542 with an Abbe refractometer (“DR-M2”, a trade name, produced by Atago Co., Ltd.).

### (5) Linear Expansion Coefficient

With TMA (thermomechanical analysis), a piece of the film having a thickness of about 150 μm, a length of 10 mm and a width of 5 mm is fixed vertically and applied with a load of 4 g with a probe, and the temperature is once increased from room temperature to 300° C. at a rate of 5° C. per minute for removing the thermal history of the film. The temperature is again increased from room temperature at a rate of 5° C. per minute, and the linear expansion coefficient is obtained from the gradient of the elongation of the film piece within a range of from 30 to 300° C.

### (6) Total Light Transmittance

It is measured within a wavelength range of from 190 to 700 nm with an ultraviolet and visible spectrometer (“V-550”, a trade name, produced by JASCO Corp.) using a cast film having a thickness of 100 μm prepared from the polymer.

### Example 1

### 5-Phenylbicyclo[2.2.1]hept-2-ene Homopolymer, i.e., Aromatic Ring-Containing Norbornene Addition Polymer

0.91 part of (allyl) palladium (1,3-dimesitylimidazolin-2-ylidene) chloride and 1.66 parts of sodium tetrakis[3,5-bis(trifluoromethyl)phenyl]borate were placed in a glass reactor with air inside thereof replace by nitrogen, and subsequently, 398 parts of methylene chloride was added thereto to prepare a catalyst liquid.

318 parts of 5-phenylbicyclo[2.2.1]hept-2-ene (molecular weight: 170) and 640 parts of methylene chloride as a polymerization solvent were charged in a pressure-resistant glass reactor equipped with a stirrer with air inside thereof replace by nitrogen, to which the catalyst liquid was added to initiate polymerization. After reacting at 40° C. for 1 hour, the polymerization reaction liquid was poured into a large amount of methanol to separate out the polymer completely, which was then filtered, washed and dried under reduced pressure at 50° C. for 18 hours to give 236 parts of a polymer (1). The thus-obtained polymer (1) was soluble in toluene, chloroform and the like. The evaluation results of the characteristics (weight average molecular weight (Mw), number average molecular weight (Mn), composition of monomer units and glass transition temperature (Tg)) of the polymer (1) are shown in Table 1.

Upon measuring the glass transition temperature of the polymer, thermal decomposition occurred at 350° C. before a glass transition temperature was observed. Accordingly, the glass transition temperature was not lower than 350° C., and thus expressed as “350 (° C.)≦” in Table 1.

### Example 2

### Copolymer of bicyclo[2.2.1]hept-2-ene with 1,4-methano-1,4,4a,9a-tetrahydro-9H-fluorene, i.e., Aromatic Ring-Containing Cycloolefin Addition Polymer

8.2 parts of N,N′-bis-(2-methylphenyl)benzamidinate nickel (triphenylphosphine) chloride and 825 parts of a toluene solution of methylaluminoxane having an aluminum content of 9.0% were placed in a glass reactor with air inside thereof replace by nitrogen, and subsequently, 500 parts of toluene was added thereto to prepare a catalyst liquid.

1,175 parts of bicyclo[2.2.1]hept-2-ene (molecular weight: 94), 2,300 parts of 1,4-methano-1,4,4a,9a-tetrahydro-9H-fluorene (molecular weight: 180) and 5,000 parts of toluene as a polymerization solvent were charged in a pressure-resistant glass reactor equipped with a stirrer with air inside thereof replace by nitrogen, to which the catalyst liquid was added to initiate polymerization. After reacting at 25° C. for 10 hours, the polymerization reaction liquid was poured into a large amount of methanol to separate out the polymer completely, which was then filtered, washed and dried under reduced pressure at 50° C. for 18 hours to give 2,158 parts of a polymer (2). The thus-obtained polymer (2) was soluble in toluene, chloroform and the like. The evaluation results of the characteristics of the polymer (2) are shown in Table 1.

Upon measuring the glass transition temperature of the polymer, thermal decomposition occurred at 350° C. before a glass transition temperature was observed. Accordingly, the glass transition temperature was not lower than 350° C., and thus expressed as “350 (° C.)≦” in Table 1.

### Example 3

### Copolymer of 5-ethylidenebicyclo[2.2.1]hept-2-ene with 1,4-methano-1,4,4a,9a-tetrahydro-9H-fluorene, i.e., Aromatic Ring-Containing Cycloolefin Addition Polymer

0.77 part of (allyl) palladium (tricyclohexylphosphine) chloride and 1.14 parts of lithium tetrakis[pentafluorophenyl]borate were placed in a glass reactor with air inside thereof replace by nitrogen, and subsequently, 2 parts of toluene was added thereto to prepare a catalyst liquid.

1,800 parts of 5-ethylidenebicyclo[2.2.1]hept-2-ene (molecular weight: 120), 1,820 parts of 1,4-methano-1,4,4a,9a-tetrahydro-9H-fluorene, 521 parts of styrene as a molecular weight modifier and 4,640 parts of toluene as a polymerization solvent were charged in a pressure-resistant glass reactor equipped with a stirrer with air inside thereof replace by nitrogen, to which the catalyst liquid was added to initiate polymerization. After reacting at 60° C. for 2.5 hours, the polymerization reaction liquid was poured into a large amount of methanol to separate out the polymer completely, which was then filtered, washed and dried under reduced pressure at 50° C. for 18 hours to give 2,201 parts of a polymer (3). The thus-obtained polymer (3) was soluble in toluene, chloroform and the like. The evaluation results of the characteristics of the polymer (3) are shown in Table 1.

### Comparative Example 1

### Copolymer of Ethylene with 1,4-methano-1,4,4a,9a-tetrahydro-9H-fluorene, i.e., Copolymer of Ethylene with Aromatic Ring-Containing Norbornene Monomer

865 parts of toluene, 100 parts of 1,4-methano-1,4,4a,9a-tetrahydro-9H-fluorene and 5.77 parts of triisobutylaluminum dissolved in 19.8 parts of n-hexane were placed in a pressure-resistant glass reactor equipped with a stirrer. 173 parts of toluene, 0.2 part of rac-ethylenebis(1-indenyl)zirconium dichloride, 3.85 parts of triisobutylaluminum dissolved in 13.2 parts of n-hexane, and 0.44 part of trityl tetrakis(perfluorophenyl)borate were mixed in an another glass reactor and added to the reactor above. Ethylene gas at 0.2 MPa was introduced thereto to initiate polymerization at 40° C. After polymerizing for 30 minutes, the polymerization reaction liquid was poured into a large amount of hydrochloric acidic methanol to separate out the polymer completely, which was then filtered, washed and dried under reduced pressure at 60° C. for 15 hours to give 114 parts of a polymer (C1). The evaluation results of the characteristics of the polymer (C1) are shown in Table 1.

### Comparative Example 2

### Addition Polymer of Only Cycloolefin Having No Aromatic Ring

8.2 parts of N,N′-bis-(2-methylphenyl)benzamidinate nickel (triphenylphosphine) chloride and 825 parts of a toluene solution of methylaluminoxane having an aluminum content of 9.0% were placed in a glass reactor with air inside thereof replace by nitrogen, and subsequently, 500 parts of toluene was added thereto to prepare a catalyst liquid.

1,175 parts of bicyclo[2.2.1]hept-2-ene, 2,230 parts of 5-hexylbicyclo[2.2.1]hept-2-ene (molecular weight: 178) and 4,000 parts of toluene as a polymerization solvent were charged in a pressure-resistant glass reactor equipped with a stirrer with air inside thereof replace by nitrogen, to which the catalyst liquid was added to initiate polymerization. After reacting at 60° C. for 2.5 hours, the polymerization reaction liquid was poured into a large amount of methanol to separate out the polymer completely, which was then filtered, washed and dried under reduced pressure at 50° C. for 18 hours to give 2,834 parts of a polymer (C2). The thus-obtained polymer (C2) was soluble in toluene, chloroform and the like. The evaluation results of the characteristics of the polymer (C2) are shown in Table 1.

TABLE 1

| | | | | | Comparative | Comparative |
|---|---|---|---|---|---|---|
| | | Example 1 | Example 2 | Example 3 | Example 1 | Example 2 |
| | | Polymer | | | | |
| Monomer composition (mol) | | (1) | (2) | (3) | (C1) | (C2) |
| Cycloolefin | 5-phenylbicyclo[2.2.1]hept- | 100 | — | — | — | — |
| monomer | 2-ene monomer unit | | | | | |
| unit having | 1,4-methano-1,4,4a,9a- | — | 40 | 39 | 38 | — |
| aromatic | tetrahydro-9H-fluorene | | | | | |
| ring | monomer unit | | | | | |
| Cycloolefin | bicyclo[2.2.1]hept-2-ene | — | 60 | — | — | 51 |
| monomer | monomer unit | | | | | |
| unit having | 5-ethylidene-bicyclo[2.2.1]hept- | — | — | 61 | — | — |
| no aromatic | 2-ene monomer unit | | | | | |
| ring | 5-hexylbicyclo[2.2.1]hept- | — | — | — | — | 49 |
| | 2-ene monomer unit | | | | | |

| | | | | | |
|---|---|---|---|---|---|
| Ethylene monomer unit | — | — | — | 62 | — |
| Mn (×10⁴) | 11.0 | 7.3 | 15.6 | 5.0 | 13.4 |
| Mw (×10⁴) | 19.0 | 18.8 | 37.6 | 13.1 | 31.4 |
| Glass transition temperature | 350 ≦ (Thermal | 350 ≦ (Thermal | 327 | 153 | 199 |
| (° C.) | decomposition) | decomposition) | | | |
| Refractive index | 1.623 | 1.592 | 1.589 | 1.573 | 1.532 |
| Total light transmittance (%) | 90 | 91 | 90 | 90 | 91 |

### Example 4

### Composite Material and Molded Article

100 parts of the 5-phenylbicyclo[2.2.1]hept-2-ene homopolymer (1) obtained in Example 1 was dissolved in 240 parts of toluene, and 60 parts of silica having an average particle diameter of 15 μm was added thereto to give a composite material (1). The thus-obtained composite material (1) was applied on a glass plate coated with polytetrafluoroethylene and dried at room temperature for hours under ordinary pressure, followed by drying at 100° C. for 7 hours, to give a cast film as a molded article of the composite material (1) containing silica as an inorganic material. The thus-obtained cast film had a refractive index of 1.629. Upon measuring the glass transition temperature, decomposition occurred at 350° C. before a glass transition temperature was observed. The results are shown in Table 2.

TABLE 2

| | Example 4 | Example 5 |
|---|---|---|
| Composite material | (1) | (2) |
| Polymer | (1) | (1) |
| (part) | 100 | 100 |
| Inorganic material | silica | glass cloth |
| (part) | 60 | 50 |
| Glass transition | 350 ≦ (thermal | 350 ≦ (thermal |
| temperature (° C.) | decomposition) | decomposition) |
| Refractive index | 1.629 | 1.630 |

### Example 5

100 parts of the 5-phenylbicyclo[2.2.1]hept-2-ene homopolymer (1) obtained in Example 1 was dissolved in 240 parts of toluene, and 50 parts of a glass cloth (E-Glass, density: 95 per 25 mm in Machine Direction, 95 per 25 mm in Transverse Direction, mass: 18 g/m², thickness: 16 μm), as an inorganic material, surface-treated with aminosilane was impregnated with the toluene solution to give a composite material (2). The thus-obtained composite material (2) was dried at room temperature for 16 hours under ordinary pressure, followed by drying at 100° C. for 7 hours, to give a cast film as a molded article of the composite material (2) containing glass fibers, treated with a silane coupling agent, as an inorganic material. The thus-obtained cast film had a refractive index of 1.630. Upon measuring the glass transition temperature, decomposition occurred at 350° C. before a glass transition temperature was observed. The results are shown in Table 2.

It is understood from the results in Table 1 that the copolymer of ethylene with a cycloolefin having an aromatic ring has a somewhat high refractive index but has a significantly low glass transition temperature (Comparative Example 1). The polymer consisting of only a cycloolefin having no aromatic ring exhibits a somewhat high glass transition temperature but has a low refractive index (Comparative Example 2). The aromatic ring-containing cycloolefin addition polymers of the invention, on the other hand, have a high glass transition temperature and a high refractive index (Examples 1 to 3).

It is understood from the results in Table 2 that the polymer of the invention can provide a higher refractive index when formed into a composite material (Examples 4 and 5).

1. A cycloolefin addition polymer consisting essentially of a cycloolefin monomer unit and containing as an essential component a norbornene monomer unit having an aromatic ring.

2. The cycloolefin addition polymer according to claim 1, wherein the proportion of the norbornene monomer unit having an aromatic ring is 20% by mol or more based on the total cycloolefin monomer unit.

3. The cycloolefin addition polymer according to claim 1, wherein the polymer has a polystyrene-equivalent number average molecular weight of from 5,000 to 800,000.

4. A cycloolefin addition polymer consisting essentially of a norbornene monomer unit having an aromatic ring.

5. The cycloolefin addition polymer according to claim 4, wherein the polymer has a polystyrene-equivalent number average molecular weight of from 5,000 to 500,000.

6. The cycloolefin addition polymer according to claim 1, wherein the norbornene monomer unit having an aromatic ring has neither a halogen atom nor a functional group.

7. The cycloolefin addition polymer according to claim 1, wherein the polymer has a glass transition temperature of 200° or higher.

8. The cycloolefin addition polymer according to claim 1, wherein the polymer has a thermal decomposition starting temperature of 200° or higher.

9. The cycloolefin addition polymer according to claim 1, wherein the polymer has a refractive index of from 1.54 to 1.80.

10. A composite material comprised of the cycloolefin addition polymer according to claim 1 and an inorganic material.

11. The composite material according to claim 10, wherein the inorganic material is an oxide of at least one metal selected from the group consisting of silicon, aluminum, titanium and zirconium, or a siloxane compound.

12. The composite material according to claim 10, wherein the inorganic material is glass fibers surface-treated with a silane coupling agent.

13. A molded article obtained by molding the cycloolefin addition polymer according to claim 1 or the composite material.

14. An optical material comprised of the molded article according to claim 13.
